(19) United States
(12) Patent Application Publication
(10) Pub. No.: US 2019/0038935 A1
(43) Pub. Date: Feb. 7, 2019

(54) EXERCISE GAME AND APPARATUS EMPLOYING COLOR-CHANGING BASE LOCATIONS

(71) Applicant: Timofey Ignatyev, Orangevale, CA (US)

(72) Inventor: Timofey Ignatyev, Orangevale, CA (US)

(21) Appl. No.: 15/670,856

(22) Filed: Aug. 7, 2017

(51) Int. Cl. A63B 24/00; A63F 13/816; A63B 71/06

(52) U.S. Cl. CPC A63B 24/0062; A63F 13/816; A63B 2024/0081; A63B 71/0622; A63B 71/06

(57) ABSTRACT

The invention is a foot-race game and associated apparatus which allows play by an individual or between a group of individuals or teams. The apparatus which is used in conjunction with the game employs physical base locations, where each base location is in communication with a computer. The computer issues commands for the base locations to emit one-colored light where different base locations emit different light colors corresponding to light colors assigned to different players. Before the game each player is assigned a color and must run to the base location emitting his color. The computer randomly shifts colors between base locations so that the player must chase his color between base locations as the game is played.

### CROSS-REFERENCE TO RELATED APPLICATIONS

Not Applicable

### BACKGROUND OF THE DISCLOSURE

### Technical Field of the Disclosure

This invention relates to games which are played in a competitive group format, and more specifically, to an exercise game and apparatus which involves competitors running to be first to random-colored base locations.

### Description of the Related Art

Competitive running games have historically been popular. Games such as tag, kick the can, and others are well known in this genre. Typically, these games required no technology to play them and could be implemented spontaneously. While these games are still played today, the popularity of computers has created technology which competes for the recreational time of a typical youth. Computer gaming has taken over a large part of the lives of children and youths to the point that, by in large, exercise games have lost their appeal in comparison. Decades ago, it was the norm for children to play outside until they were called to dinner or until the sun set. Now, video games occupy the free time of children to an unhealthy level such that childhood obesity and a lack of muscular development has become epidemic.

Technology can be used to play a healthy role in the physical development and recreational time which children experience. In fact, due to the fact that children respond positively to digital devices, the incorporation of technology into their play time can often be an attractive incentive for them to participate. Without the incorporation of a technical aspect, some children can rapidly lose interest in the prospect of physical exercise.

Therefore, a need exists for a game which inspires vigorous physical exercise, yet incorporates technology, whether it be in the form of an apparatus, computer or digital aspects, or all of the above. The present invention fills this need by presenting a game which inspires physical exercise and combines aspects of an apparatus, Wi-Fi technology and a computer for running the apparatus. The inventive game can be played inside or outside and appeals to children as well as to adults.

### SUMMARY OF THE DISCLOSURE

The invention is a game and associated apparatus which allows play by a single player, between a group of individuals or teams. The object of the inventive game is to inspire vigorous running exercise in a competitive format between a group of individuals or between teams. A further object of the game is to reward individuals or teams who reach a physical base location first. The reward can be in the form of points, for example, where the points can progressively increase, depending on how many times an individual or group member reaches a physical base location first, before the other individuals or teams which are in the competition.

The apparatus which is used in conjunction with the game is comprised of a plurality of physical base locations, where each base location, in communication with a computer, is capable of producing random visible colors. The colors produced by a base location at any one time correspond to a color assigned to an individual or team that is playing the game. For example, at one point in time a particular base location might produce a visible blue color, thus causing the “blue” individual or team to run toward that base location. At the same time, another of the plurality of base locations might simultaneously produce a visible red color, thus causing the “red” individual or team to run toward that base location. The competitive aspect results from the game offering a reward to the individual or team who reaches the base indicating their assigned color, first.

In another aspect of the invention, the physical base locations can be presented as an actual colored base, similar to that of bases found in baseball, or a mat, except the bases randomly changes colors in response to commands received from a central computer. The color change commands sent from the central computer can be sent either in a wired format or, preferably wirelessly, such as by Wi-Fi, for example. Wi-Fi is preferable to a wired format due to the propensity for players to trip over wires, thus creating a safety hazard. Also, a wireless format increases the flexibility for placing the base locations, which are not limited by wires. It is also contemplated that the computer could obtain information or software for playing the game by accessing the internet and a cloud network of computers.

In another aspect of the invention, the physical base locations can be represented by a stand which attaches to a light bar wherein the light bar has a plurality of colored lights which can be individually lit, depending on the random color command issued by the computer.

The physical base location also must have a way for a player to register his arrival at the base location. If the base location is a base or a mat, a pressure pad or sensor is incorporated which would cause a color to be registered when the player merely steps on the base or mat. If the base location includes a light bar, the light bar might have a hand-button which a player could push upon his arrival at the base location. Regardless of how a player's arrival is registered, the computer receives the input of the registration and calculates which player arrived at his assigned color first and assigns a point total to that player, the computer immediately changes colors of the bases in random format and the game continues. Additionally, if point totals are to be awarded to second place, third place, etc., the computer can assign those totals to the appropriate player or teams as well.

In the preferred embodiment, the players play a timed game where the players run toward their colors during a set period. As soon as any player reaches their assigned color first, the first-place player's arrival is registered and points can be assigned to that player. Immediately after the first-place player's arrival is registered, the colors randomly change between the bases, and the players run toward their color once again. In this way, whenever the first-place player arrives, points are tallied for that player and the colors immediately change, thus keeping the running game continuously going, without significant pause. It is this constant running without significant pause, which makes this game especially worthwhile from an exercise perspective.

The main objective of the inventive game is to cause its participants to run vigorously in a foot race format between the randomly colored bases and to do so competitively so that the participants are inspired by the thought of running up the largest tally of points and winning the game. Another objective of the game is to marry technology with an old-style running game so as to keep the game interesting for children who are often raised on technology and are used to having a technological aspect to their gaming.

### BRIEF DESCRIPTION OF THE DRAWINGS

FIG. 1 is a plan view of a playing field with the apparatus comprising pressure mat-style base locations installed thereon and associated Wi-Fi computer, wherein the base locations are color-illuminated as they would appear in typical game play.

FIG. 2 is a plan view of the playing field with the apparatus installed thereon of FIG. 1, with the base locations being color-illuminated during a later time than that shown in FIG. 1, the base locations showing random colors different than those from FIG. 1.

FIG. 3A is a plan view of a pressure mat-style base location.

FIG. 3B is a side view of the pressure mat-style base location of FIG. 3A.

FIG. 4 is an alternate embodiment of a base location comprised of a light array attached to a stake for driving into the ground at an outdoor location.

FIG. 5 is a further alternate embodiment of a base location, showing a pressure mat attached to a separate light array.

FIG. 6 is an alternate embodiment of a base location adapted for both indoor and outdoor use.

FIG. 7 is a further alternate embodiment of a base location.

FIG. 8 is a schematic view of a plurality of base locations with light arrays and pressure mats in communication with a Wi-Fi computer.

FIG. 9 is a schematic view of a plurality of base locations which are comprised of a master base location and a plurality of slave base locations.

FIG. 10 is a schematic of a map of base locations that is reproducible by using a GPS component to set up the map.

### DETAILED DESCRIPTION OF THE DRAWINGS

The invention is a game and associated apparatus which allows play between a group of individuals or teams or by a single player. The object of the inventive game is to inspire vigorous running exercise in a competitive foot race format between a group of individuals or between teams. A further object of the game is to reward individuals or teams who reach a physical base location first. The reward can be in the form of points, for example, where the points can progressively increase, depending on how many times an individual or team member reaches a physical base location first, before the other individuals or teams which are in the competition.

The apparatus which is used in conjunction with the game is comprised of a plurality of physical base locations, where each base location is capable of producing random visible colors. The colors produced by a base location at any one time correspond to a color assigned to an individual or team that is playing the game. For example, at one point in time a particular base location might produce a visible blue color, thus causing the “blue” individual or team to run toward that base location. At the same time, another of the plurality of base locations might simultaneously produce a visible red color, thus causing the “red” individual or team to run toward that base location. The competitive aspect results from the game offering a reward to the individual or team who reaches the base indicating their assigned color, first.

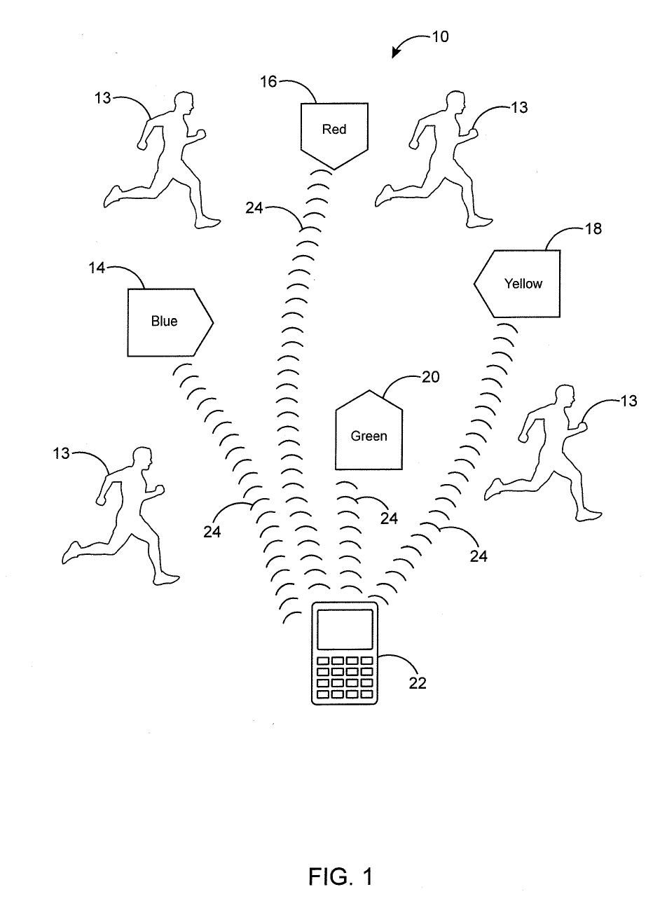

Referring now to FIG. 1, the inventive apparatus 10 for playing the game is shown as it might be laid out at an outdoor location 12, such as a back yard, a field or a park. In this view, there are four base locations shown 14, 16, 18 and 20. A computer 22 is located sufficiently close to the base locations so that the computer can communicate wirelessly 24 with each base location. Preferably, the computer can communicate with the base locations while maintaining a sufficient distance from the area of play so that the players 13 will not accidentally contact the computer and damage it. In FIG. 1, the base locations 14, 16, 18 and 20 are shown activated as they might appear during normal game play, with each base location lit according to its assigned color for that point in time.

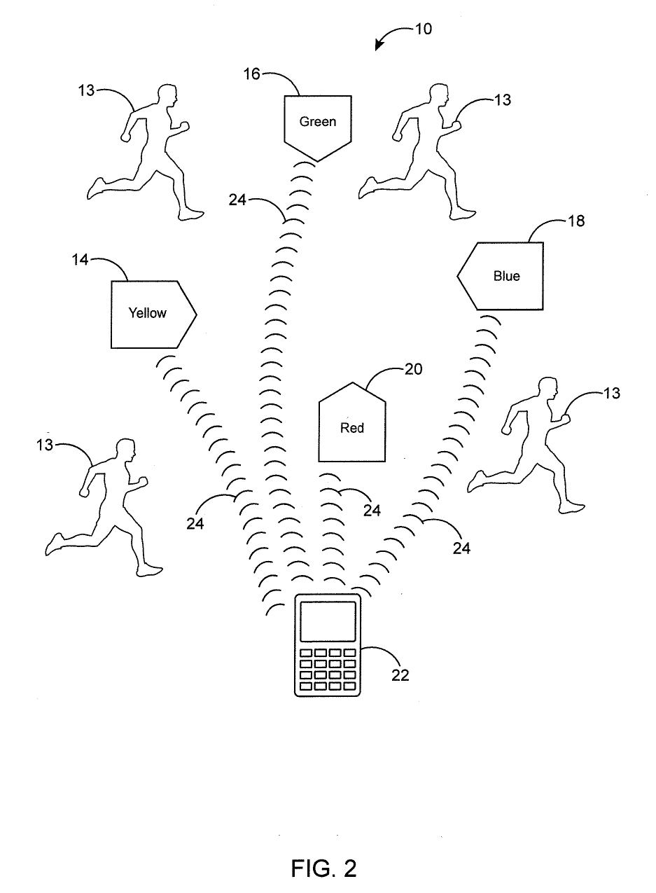

FIG. 2 represents a similar view of the inventive apparatus 10 as that introduced in FIG. 1, this view showing another point in time where the base locations 14, 16, 18 and 20 are emitting different colors than those shown in FIG. 1. The new colors associated with each base location were randomly selected by the computer 22. During play, if the color configuration of FIG. 1 was deployed, and base location 16 was assigned the color red by the computer, then the “red” player would need to race to toward base location 14 during the time period of game play shown in FIG. 1. Later in the game, when the base locations have randomly changed color as shown in FIG. 2, the color red is assigned randomly to base location 20 and the “red” player would now have to race toward this new base location. Likewise, for the players assigned other colors, they would have to race toward their matching base location in FIG. 1 or FIG. 2 as the computer randomly associates colors with base locations 14, 16 18 and 20 as the game is being played.

The number of base locations is not necessarily limited by the spectrum of colors. It is preferable that the colors be easily discernable to the human eye, so naturally, a plurality of bases associated with defined colors such as red, green, blue, orange, yellow and purple colors would be a good selection and easily discernable. With these six colors, a game could be played involving six base locations for six players. More players could be added by adding less discernable colors on the color spectrum; for example, light blue and dark blue; purple and fuchsia; red and pink. However, at some point, if too many colors are used, they can become blended and no longer discernable. In such instances, one solution would involve setting up more than one game and apparatus to accommodate more players. An additional solution would be to form the players into teams where the number of base locations would equal the number of players and the colors would equal the number of teams. For example, if there are 20 players, there can be four teams of five players each, where each team is assigned a color for four colors total. In such a team scenario, the five players on each team would be running to five different base locations emitting the same color. Points would be tallied based on the time period it takes every player to reach their assigned base location and then totals could be added up for each team to determine place-order of teams to determine a winner. With a team approach, the inventive game and apparatus could be played by a multitude of players and would be applicable to a physical education class, a company picnic event, or a large party to name some examples where large numbers could be accommodated by the game and apparatus.

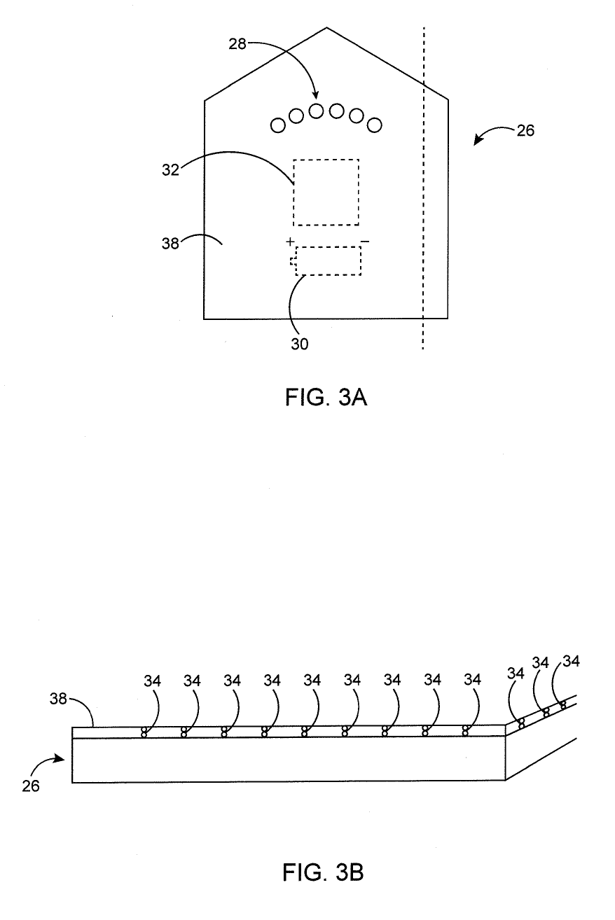

Referring now to FIGS. 3A and 3B, shows a base location 26 which comprises part of the apparatus. The base locations can be made in the form of a mat or even similar to a base as used in the game of baseball. The base locations include a lighting mechanism such as a light emitting diode (LED) array 28. The random colors can be achieved if the LEDs in the array have primary color red, green and blue emitters. Different colors can be achieved by color mixing ratios of the red, blue and green colors as described in the article “Understand RGB LED Mixing Ratios to Realize Optimal Color in Signs and Displays” by Lee Boon Hooi, LEDs Magazine, June 2013. The signal to mix a random color would be sent to the LED array 28 by the computer 22 via Wi-Fi connection 24. It is also contemplated that the computer could obtain information or software for playing the game by accessing the internet and a cloud network of computers. For example, game updates could be downloaded to the computer 22 by access to the cloud.

As the game is played, the computer 22 will send random signals to the LED array 28 of each base location 26 which reflect the colors chosen for each individual or team. The LEDs are powered by a battery 30, which lights the LEDs and provides electrical power for other functions, such as the transmitter and receiver (combined into a transceiver 32 in FIG. 3A). As each game is played, the computer will continue to send signals to the base locations to mix a certain color and change up the colors at each base location as the games are played. Each base location has a receiver portion of transceiver 32 to receive the signals transmitted wirelessly by the computer. The receiver transmits the light mixing signals to the LED array 28 to result in the color assigned by the computer 22 to a particular base location 26.

FIG. 3B is a side cutaway view along line A-A of FIG. 3A, of the base location 26. Pressure indicators 34 distributed beneath the top surface 38 of base location 26 allow the player to use his foot to register the player's arrival at the base location 26. Pressure indicators 34 can be pressure switches, which close a circuit when the player steps on the top surface 38 of the base location. Pressure indicators can also be pressure sensors. The player would step on the base location, similar to a player arriving at a base in the game of baseball. The pressure indicators 34 are in communication with the transceiver 32. Once the pressure indicator 34 actuated, the transmitter portion of the transceiver would transmit the player's arrival to the computer 22 so that the computer could register the player's arrival and assign a place value and point tally for the player. The computer would also associate the place value and point tally to the player's color. The computer would keep track of the point tally and place value for each player color as the game progresses.

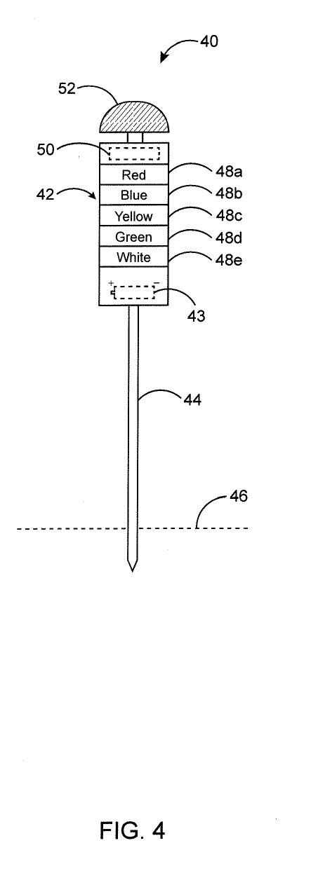

Referring to FIG. 4, an alternative embodiment 40 for a base location is shown. This embodiment comprises a light array 42 attached to an elongate stake 44 which can be inserted into the ground 46. The light array 42 as shown has individual light bars 48 A-E; here shown as red 48A, blue 48B, yellow 48C, green 48D, and white 48E lights. Additional colors could be added, or else the light array could have color-mixing LEDs as previously described for the embodiment of FIGS. 3A and 3B. The white light bar 48E is intended to be separate from the colored game lights 48A-48D and functions to illuminate the base location 40 for playing the game at night. A Wi-Fi transceiver 50 is present to communicate with the computer 22. This could be a Bluetooth® transceiver module, for example or any radio transceiver. Light array 42 includes a rechargeable battery 43. This embodiment employs a push button 52 to register a player's arrival at the base location 40. The computer 22 is programmed to randomly light colors on the light array 42 of each base location 40 during game play, and to receive a signal from the base location 40 registering a player's arrival and assign a place value and point tally for the player. The computer 22 would also associate the place value and point tally to each player's color. The computer would keep track of the point tally and place value for each player color as the game progresses.

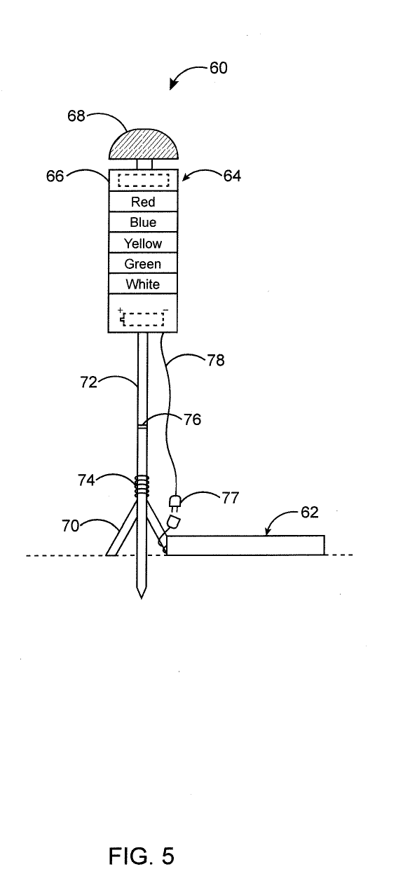

FIG. 5 illustrates a further alternate embodiment of the base location 60 where a mat 62 having a pressure indicator is married to the light array 64. In this embodiment, the mat 62 would function as a first means for registering the arrival of a player only and would not incorporate its own independent light array. Instead, the pressure mat 62 would register the arrival of a player, the pressure mat communicating with the Wi-Fi transceiver 66 of the light array 64. The Wi-Fi would then transmit the player's arrival to the computer. A push button 68 for registering a player's arrival could also be incorporated as shown, in addition to the pressure mat 62 as a further way to register the arrival of the player, thus giving a player the option of two means for registering his arrival. This embodiment also has retractable legs 70 attached to the stake 72 for stabilizing the stake 72 and light array 64. The stake 72 also incorporates a spring section 74 along its length to absorb any impact to the light array, for example, thus keeping the stake and light array from tipping over during play. The stake can also be adjustable in height by using a détente mechanism 76. In this embodiment, the pressure mat 62 can be connected by a wire 78 and detached 77 if it is desired to only play with the stake 72 and light array 64 portions. The light array 64 is also detachable from the stake 72 for easy storage.

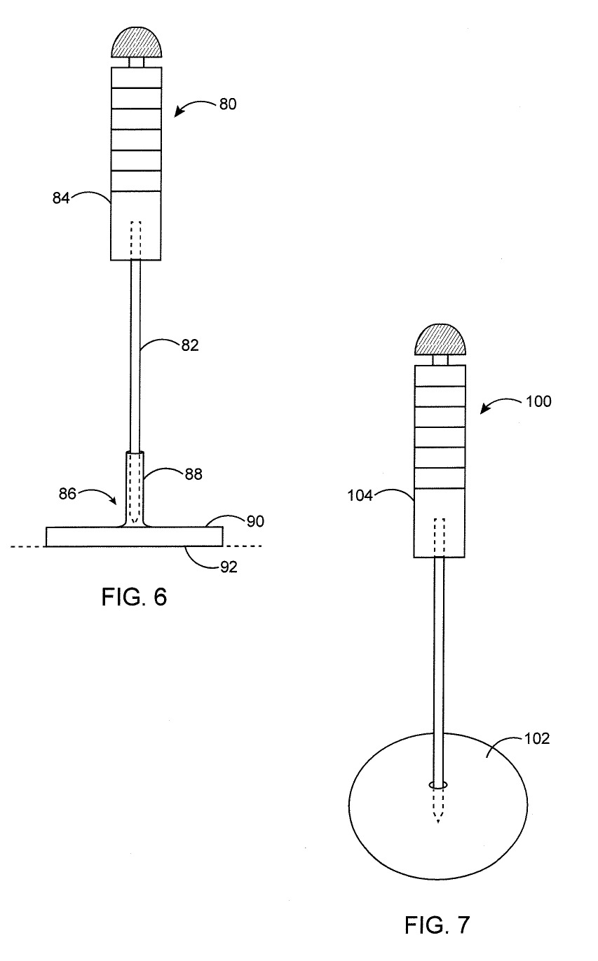

FIG. 6 illustrates a further alternate embodiment 80 of the base location wherein the stake 82 and light array 84 remain as previously described, but a stand 86 is supplied for inserting the stake 82. This embodiment is especially adaptable to situations where hard ground is present and the stake cannot be driven in easily. This embodiment also works well in indoor environments, such as a gym. The stand has a cavity portion 88 attached to a base 90; the bottom of the base includes an anti-slip surface 92. The anti-slip surface 92 has utility on smooth surfaces such as with an indoor gym floor. The base 90 could also be configured as a pressure mat to operate to register the arrival of a player, as previously described herein.

FIG. 7 illustrates yet a further alternate embodiment 100 of the base location which is used for outdoor play where the light array is attached to a stake for placement into the ground. The pressure mat 102 is attached to the light array 104 to provide two means of registering a player's arrival. The stake 106 of the light array 104 inserts through the center of a round-shaped pressure mat 102. The round-shaped pressure mat 102 provides a player with 360-degree access for registering his arrival, by foot pressure in addition to a push button 52.

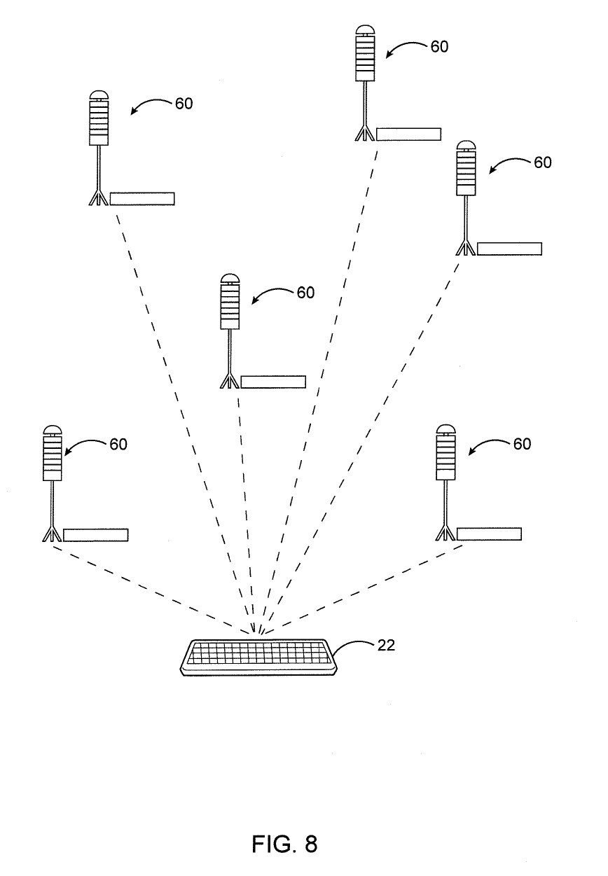

FIG. 8 shows the base location embodiment 60 of FIG. 5 set up and ready to play the inventive game. A plurality of base locations 60 are set up which communicate by Wi-Fi to the computer 22. The computer 22 can be a PC, a tablet, an iPad or even a smart phone. A Bluetooth® connection is one method of implementing Wi-Fi communication between the base locations 60 and the computer 22. Software for playing the game can be downloaded to the computer; a downloadable software application would be one method of implementing this step. The software would execute the following included steps, not necessarily in any order: allowing the input of player information, including whether the player is an individual, or part of a team; assigning colors to each player or team; allowing input as to the type of game being played and how scoring will be implemented; broadcasting color information to each base location to start game play; receiving information regarding the registration of arrival of each player to his respective base location; assigning point tallies to each player arriving at a base location.

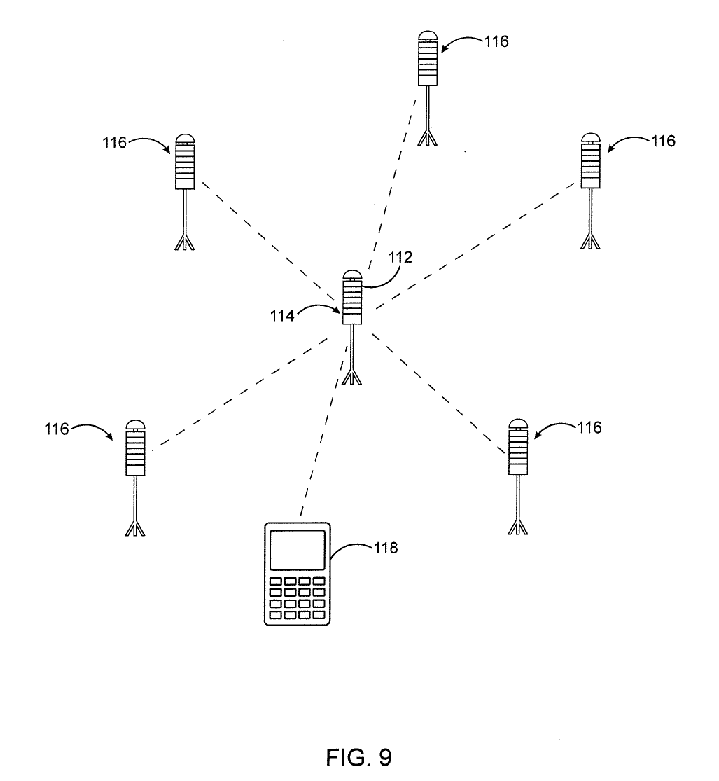

FIG. 9 shows a further embodiment of the apparatus having multiple base locations, where the computer 112 is incorporated into a master base location 114, which controls multiple slave base locations 116. This embodiment represents a self-contained version of the invention which can be set up and then the computer 112 can be programmed for game play by accessing a touch screen interface (not shown) on the master base location 114. This version would also allow programming to be transferred to a separate smart phone or tablet computer 118 to provide the inputs to computer 112, if desired. The separate smart phone or tablet computer would serve only as a user interface with the actual control occurring at computer 112.

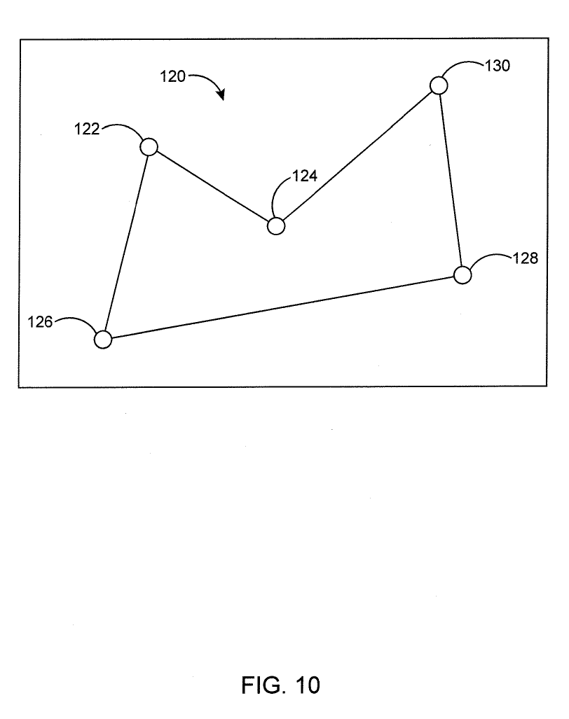

Also, a Global Positioning System (GPS) component can be incorporated into the apparatus, which measures distance between base locations and allows distance and time to be calculated as a player runs between colors over a period of time. This could be useful for athletes, as a training aid, with the goal to progressively increase an athlete's speed and performance over time. Additionally, the apparatus is capable of modifications from the embodiments shown herein. For example, the batteries of the light arrays at the base locations can be rechargeable. Referring to FIG. 10, a map 120 of base locations is reproducible by using the GPS component to set up the map 120. For example, base location 122 might be 100 feet from base location 124 and base location 126 is 150 feet from base location 128 and so on. The addition of a GPS component allows the map 120 to be reproducible by a variety of players or teams in different locations of the world. In this way, teams from different locations, countries, etc., could post and share their results via the internet on the exact same course. Also, the same lighting sequence of the base locations would have to be retained for the game to be reproducible over a distance. This would set up competitive game play over large areas of the world between a variety of players and/or teams.

The inventive game and apparatus provides a marriage of technology and a foot race game which is attractive to players and inspires them to play more. The prospect of acquiring points and winning over other competitors makes the game exciting. The game can be played indoors or outdoors; it can accommodate a multitude of individual players or teams, if desired. The simplicity of this game, which involves only chasing colors, reduces the complexity and rules requirements, making this game accessible to a wide variety of the population. Depending on how the computer is programmed, a number of game variations are possible. In another variation, the base locations could be in communication with an electronic bracelet worn by each player wherein the bracelet code is unique to each player. A wireless connection between the bracelet and base location might register the number of times a player wearing a particular bracelet reaches a base location first, this information then being relayed to the computer. In a further variation of the apparatus, the various base locations have audio capability to emit sounds when a player registers his arrival at a base location.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An apparatus for playing a foot-race game, the apparatus comprising:
a plurality of base locations, each of said plurality of base locations including a light array, said light array capable of emitting a one-colored light on a colored light spectrum in response to a random command transmitted from a computer;
each of said plurality of base locations including a registering device for registering the arrival of a player to each of said plurality of base locations, each of said plurality of base locations including a transmitter for transmitting said player arrival information to said computer;
said computer randomly transmitting colored light instructions to each of said plurality of base locations, said computer receiving said arrival information of each player from each of said plurality of base locations, said computer calculating point and place information for each player based upon said player arrival information, said computer assigning said point and place information to each player.

2. The apparatus for playing a foot-race game as recited in claim 1, wherein said base location is a mat.

3. The apparatus for playing a foot-race game as recited in claim 2, wherein said mat further comprises a pressure indicator for indicating pressure exerted upon a top surface of said mat, the registration of pressure registering the arrival of a player.

4. The apparatus for playing a foot-race game as recited in claim 1, wherein said base location is an upright light array attached to a stake.

5. The apparatus for playing a foot-race game as recited in claim 4, wherein said upright light array further comprises a push-button for registering the arrival of a player at said base location.

6. The apparatus for playing a foot-race game as recited in claim 1, wherein said computer is selected from the group consisting of: a PC, a tablet, an iPad or even a smart phone.

7. An apparatus for playing a foot-race game, the apparatus comprising:
a plurality of base locations, each of said plurality of base locations emitting a one-colored light in response to a random command transmitted from a computer in communication with said plurality of base locations, said computer commanding at least two of said plurality of base locations to emit a one-colored light from different points of a light spectrum;
each of said plurality of base location including a registering device for registering the arrival of a player to said each of said base locations, wherein each of said plurality of base locations includes a transmitter for transmitting said player arrival information to said computer;
said computer randomly transmitting colored light instructions to each of said plurality of base locations, said computer receiving said player arrival information from at least one of said plurality of base locations.

8. The apparatus for playing a foot-race game as recited in claim 7, wherein said base location is a mat.

9. The apparatus for playing a foot-race game as recited in claim 8, wherein said mat further comprises a pressure indicator for indicating pressure exerted upon a top surface of said mat, the registration of pressure registering the arrival of a player.

10. The apparatus for playing a foot-race game as recited in claim 7, wherein said base location is an upright light array attached to a stake.

11. The apparatus for playing a foot-race game as recited in claim 10, wherein said upright light array further comprises a push-button for registering the arrival of a player at said base location.

12. The apparatus for playing a foot-race game as recited in claim 7, wherein said computer is selected from the group consisting of: a PC, a tablet, an iPad or even a smart phone

13. A method for playing a foot-race game, the apparatus comprising:
providing a plurality of base locations, each of said plurality of base locations including a light array, said light array capable of emitting a one-colored light on a colored light spectrum in response to a random command transmitted from a computer;
providing a registering device for registering the arrival of a player to each of said plurality of base locations, each of said plurality of base locations including a transmitter for transmitting said player arrival information to said computer;
providing a computer, said computer randomly transmitting colored light instructions to each of said plurality of base locations, said computer receiving said arrival information of each player from each of said plurality of base locations, said computer calculating point and place information for each player based upon said player arrival information, said computer assigning said point and place information to each player.
